(19) United States
(12) Patent Application Publication
(10) Pub. No.: US 2012/0113381 A1
(43) Pub. Date: May 10, 2012

(54) ARM FOR SPECTACLES AND ASSOCIATED SPECTACLES

(75) Inventors: Herve Francois Serge Jacquier, Lisbonne (PT); Christian Francois Yves Vermet, Macao (MO)

(73) Assignee: KILLINE OPTICAL LTD., Macao (MO)

(21) Appl. No.: 13/383,863

(22) PCT Filed: Jul. 20, 2009
(86) PCT No.: PCT/FR09/51439

§ 371 Date: Jan. 16, 2012

(51) Int. Cl. G02C 11/02

(52) U.S. Cl. 351/51

(57) ABSTRACT

The invention relates to an arm (2) for spectacles (1) including a frame (6), characterized in that it comprises at least one decorative sleeve (7) at least partially made of an elastically deformable material, provided with at least one decorative surface (70a, 70b) and mounted around the frame (6) of the arm (2), said sleeve (7) being designed to turn and/or twist around the frame (6) by means of elastic deformation in order to modify the appearance of said arm (2). The invention also relates to the spectacles (1) provided with such an arm (2). The present invention can be used in the field of spectacles

### TECHNICAL FIELD

The present invention relates to an arm for spectacles and spectacles equipped with such an arm.

### BRIEF DISCUSSION OF RELATED ART

In a known manner, spectacles include a face, sometimes called optical façade, provided with lenses, for example such as optical and/or solar and/or protective and/or safety lenses, said face possibly being supported by a spectacle frame, and two spectacle arms, called side arms, connected to the face or frame of the spectacles via a pin and an associated hinge.

It is common practice for a spectacle arm to include a rigid frame in particular made from steel, a composite material, or a rigid plastic, which is essentially made up of two parts, i.e. a generally straight front portion intended to be connected to the face or frame of the spectacles, and a generally curved back portion intended to fit around the back of the ear and possibly to bear on the ear.

To modify the appearance of the spectacles, and more particularly the arms of the spectacles, it is known, in particular from document US 2009/0096982 A1, to position removable decorative elements on the arms of the spectacles, with the drawback of risking losing the decorative elements by having them detach from the arms of the spectacles.

With the same aim of modifying the appearance of the arms of spectacles, documents EP 1 071 976 A1 and EP 0 901 648 A1 describe a spectacle arm including a fixed portion and a completely rigid decorative element mounted around the fixed portion and able to move between two positions by pivoting. Such decorative arms have the main drawback of having a complex and expensive design, as they require means for locking the pivoting decorative element in position. Furthermore, such a decorative element can only be mounted around a straight portion of the frame so as to allow said rigid decorative element to rotate, thereby limiting the possibilities for positioning decorative element around only these straight portions of the frame.

### BRIEF SUMMARY

The present invention in particular aims to resolve all or part of the drawbacks mentioned above, by proposing a spectacle arm provided with at least one decorative element having a simple and inexpensive design, easy for the user to manipulate to modify the appearance of the spectacle arms, and without risk of loss.

To that end, it proposes an arm for spectacles including a frame, remarkable in that it comprises at least one decorative sleeve at least partially made of an elastically deformable material, provided with at least one decorative surface and mounted around the frame of the arm, said sleeve being designed to turn and/or twist around the frame by means of elastically deformation in order to modify the appearance of said arm.

Thus, the decorative element is made with the decorative sleeve, which is mounted around the frame, such a sleeve being easy to use and having a simple and inexpensive design, as it does not require any specific locking means. Decorative surface refers to a surface provided with a decoration. Such a decoration may assume the form of a selected color and/or patterns and/or materials. Such patterns can be made in the form of raised and/or hollowed and/or colored patterns.

In fact, a first possible use of the sleeve is as follows: the sleeve is mounted, more or less tight, around the frame in a first decorative position where one of said decorative faces is exposed, then the user rotates the sleeve around the frame by elastic deformation of the sleeve (driving a torsional movement of the sleeve) until it occupies a second decorative position where another of said decorative faces is exposed, thereby modifying the appearance of the arm by exposing another decorative surface; the elasticity of the sleeve allows or enables this rotation around the frame, in particular via a torsional movement of the sleeve around the frame.

A second possible use of the sleeve is as follows: the sleeve is mounted, more or less tight, around the frame in a first decorative position where one of said decorative faces is exposed, then the user rotates only part of the sleeve around the frame by elastic deformation of the sleeve, thereby twisting or turning the sleeve around the frame until it occupies a second decorative position where the sleeve keeps its twisted position, thereby modifying the appearance of the sleeve and thus the branch in general; the elasticity of the sleeve allows or enables this twisting around the frame.

According to one feature, the sleeve is provided with at least two decorative surfaces, said sleeve being designed to turn and/or twist around the frame by elastic deformation so as to expose one and/or the other of the decorative surfaces.

Exposing one and/or the other of the decorative surfaces refers to positioning, on the outside of the arms of the spectacles, opposite the wearer of the spectacles, one and/or the other of the decorative surfaces so as to make them visible to surrounding people.

In the case of a simple rotation of the sleeve, the user goes from one decorative surface to another, while in the case of twisting of the sleeve, the user exposes several decorative surfaces at the same time or exposes only one same decorative surface deformed by the twisting of the sleeve and therefore having a distinct appearance relative to the situation where the sleeve is not twisted.

In one particular embodiment of the invention, the arm comprises several sleeves mounted around the frame of the arm, thereby making it possible to multiply the possibilities for modifying the appearance of the arm as the user wishes.

According to one feature, the sleeve at least partially fits a rear curved portion of the frame intended to fit behind the ear. This sleeve for example has a plugged end in order to cover a free end of the frame, and said sleeve forms a tip mounted around the rear portion of the frame.

According to another feature, the sleeve at least partially fits a substantially straight front portion of the frame intended to be connected to a face of the spectacles.

According to one possibility of the invention, the sleeve is mounted around a segment of the frame of the arm, said segment having a central portion and two end portions, and the sleeve is mounted without play around at least one of the portions of said segment so as to make it possible to immobilize the sleeve in position around said segment.

In a decorative position, the sleeve completely hugs the frame over at least one portion of the segment, ensuring good immobilization of the sleeve in position and thereby guaranteeing maintenance of the sleeve in its decorative position(s).

The sleeve can for example be mounted without play around:

only the central portion; or

at least one of the two end portions; or

the central portion and two end portions, so that the sleeve is mounted without play around the segment over the entire length of said segment.

According to another possibility of the invention, the sleeve is mounted around the segment of the frame of the arm, said segment having a central portion and two end portions, and the sleeve is mounted with play around at least one of the portions of said segment so as to facilitate the elastic deformation of sleeve when said sleeve rotates around said segment.

In a decorative position, the sleeve partially hugs the frame over at least one portion of the segment, space for play being provided between the sleeve and said portion(s) of this segment; said space for play corresponds to an inner housing space of the sleeve not occupied by the segment.

The sleeve can for example be mounted with play around:

only the central portion; or

at least one of the two end portions; or

the central portion and two end portions, so that the sleeve is mounted with play around the segment over the entire length of said segment.

Thus, the sleeve is mounted with play around part of the frame, which makes it possible to facilitate the elastic deformation of the sleeve when the user pivots or bends or twists the sleeve around the frame. This play in fact decreases the force necessary to rotate the sleeve around the frame.

In one particular embodiment, the sleeve is:

either mounted with play around the central portion of the segment and without play around at least one of the end portions of the segment;

or mounted without play around the central portion of the segment and without play around at least one of the end portions of the segment, thereby making it possible to facilitate the elastic deformation of the sleeve when the user wishes to change the appearance of the spectacles while guaranteeing its immobilization in the decorative position(s).

These assemblies also have the advantage of making it possible to align said sleeve with at least one element adjacent to said sleeve, i.e. to preserve the correct alignment between the sleeve and the adjacent or neighboring element(s) situated on either side of the frame segment once the sleeve is in a decorative position.

In one embodiment, the sleeve has an internal housing with a substantially constant section, and at least one of the end portions of the segment has a widened transverse section relative to the central portion of said segment and a shape substantially complementary to that of the internal housing, thereby allowing assembly with play around the central portion and assembly without play around the or each end portion.

Alternatively, the sleeve also has an internal housing with a substantially constant section, and the central portion of the segment has a widened transverse section relative to at least one of the end portions of the segment and a shape substantially complementary to that of the internal housing, thereby allowing an assembly with play around the or each end portion and assembly without play around the central portion.

In another embodiment, the segment has a substantially constant section and the sleeve has an internal housing provided with a central portion and two end portions, where at least one of the end portions of the housing has a reduced transverse section relative to the central portion of the housing and a shape substantially complementary to that of the segment, thereby allowing an assembly with play around the central portion of the segment or housing and an assembly without play around the or each end portion of the segment or housing.

Alternatively, the segment also has a substantially constant section and the sleeve has an internal housing provided with a central portion and two end portions, where the central portion of the housing has a reduced transverse section relative to at least one of the end portions of the housing and a shape substantially complementary to that of the segment, thereby allowing an assembly with play around the or each end portion of the segment or housing and assembly without play around the central portion of the segment or housing.

According to one feature, the sleeve is mounted around a segment of the frame with a non-circular transverse section so as to ensure rotational indexing of the sleeve around the frame. The sleeve, at least partially made from an elastically deformable material, can thus turn and/or twist around the non-cylindrical segment while remaining more or less tight around the segments in the decorative position(s). Thus, in the decorative position, the sleeve has no degree of rotational freedom; only an elastic deformation of the sleeve allows such a rotation and/or twist.

Non-limitingly, the segment has an oblong transverse section, for example ellipsoidal or oval, or a polygonal transverse section, for example square, rectangular, triangular, or parallelepiped, or a transverse section in the shape of a star or cross. Advantageously, the segment has rounded edges so as to avoid damaging the sleeve when it is pivoted or twisted.

The non-cylindrical segment has at least two contact surfaces with the sleeve, and the sleeve has an internal housing limited by at least two internal surfaces at least partially hugging the respective contact surfaces of the segment.

The contact surfaces of the segment can have the same number of corresponding decorative surfaces of the sleeve, such that a segment with two contact surfaces, for example having an oval transverse section, makes it possible to have a sleeve offering two decorative surfaces; a segment with three contact surfaces, for example having a triangular transverse section, makes it possible to have a sleeve offering three decorative surfaces.

In the case of a segment with only two contact surfaces, the sleeve can occupy a first decorative position in which the first, second, respectively, internal face of the housing of the sleeve hugs the first, second, respectively, contact surface of the segment of the frame. After a 180° rotation of the sleeve, the latter occupies the second decorative position in which the first, second, respectively, internal face of the housing of the sleeve hugs the second, first, respectively, contact surface of the segment of the frame. It is also possible to consider twisting the sleeve such that part of the first internal face of the housing of the sleeve hugs the first contact surface of the segment, while a second part of the first internal face of the housing of the sleeve hugs the second contact surface of the segment.

In the case of a segment with only three contact surfaces, the sleeve can occupy a first decorative position in which the first, second and third internal faces of the housing, respectively, fit the first, second and third contact surfaces of the segment, respectively. After a first 120° rotation of the sleeve, the latter occupies a second decorative position in which the first, second and third internal faces of the housing, respectively, hug the second, third and first contact surfaces of the segment, rotation. After a second 120° rotation of the sleeve, the latter occupies a third decorative position in which the first, second and third internal faces of the housing, respectively, hug the third, first and second contact surfaces of the segment, respectively.

It is of course possible to consider providing a segment with four or more contact surfaces, thereby defining at least four decorative positions of the sleeve when the latter is simply turned, without counting the positions caused by twisting of the sleeve.

Alternatively, the sleeve is mounted around a segment of the frame with a circular transverse section, and the adhesion between the sleeve and the segment is sufficient to keep the sleeve in a twisted position around said segment. In that scenario, the sleeve can for example twist by elastic deformation around said cylindrical segment, the maintenance in position of the sleeve in a twisted position being essentially ensured by adhesion between the sleeve and the frame.

In one particular embodiment, the sleeve is made by molding at least one elastically deformable material. This molding can for example be done using an injection molding technique.

In this way, the sleeve can be positioned all along the arm frame, at different locations and over different lengths, more or less significant.

According to one possibility of the invention, the sleeve is made completely from an elastically deformable material.

According to another possibility of the invention, the sleeve comprises at least one first part completely made from an elastically deformable material, and at least one second rigid part secured to the first part and defining at least one decorative surface.

According to other features:

the first part is made in the form of a ring of elastically deformable material, and the second part comprises a rigid wall fixed on the perimeter of the first part and which at least partially surrounds said first part; or

the first part and the second part each form and a half-ring respectively made from an elastically deformable material and a rigid material, said first and second parts being joined to one another to form the sleeve together; or

the sleeve comprises at least two first parts made in the form of rings of an elastically deformable material and at least one second part made in the form of a ring rigid material, said first parts being fixed on the end of the second part so as to frame said second part and make it possible to immobilize the sleeve around the frame.

The invention also relates to spectacles comprising at least one arm according to the invention.

### BRIEF DESCRIPTION OF THE DRAWINGS

Other features and advantages of the present invention will appear upon reading the detailed description below, of eight non-limiting embodiments, done in reference to the appended figures, in which:

FIG. 1 is a front view of spectacles according to a first embodiment of the invention;

FIG. 2a is a side view of the spectacles of FIG. 1 illustrating the assembly of a decorative sleeve around the frame of the arm;

FIG. 2b is a few identical to that of FIG. 2a, where the decorative sleeve has been removed to bare the frame of the arm;

FIGS. 3a and 3b are transverse cross-sectional views of the arm of the spectacles illustrated in FIG. 2a, along axes AA and BB, respectively, illustrating the assembly of the decorative sleeve around two distinct portions of the arm frame;

FIG. 3c is a view identical to that of FIG. 3b illustrating the decorative sleeve during pivoting;

FIG. 4a is a partial perspective view of spectacles of the same type as those illustrated in FIGS. 1 to 3, equipped with decorative sleeves around the respective frames of the two arms;

FIG. 4b is a view identical to that of FIG. 4a, where the decorative sleeves have been removed to bare the frames of the two arms, with the illustration of one of the decorative sleeves removed;

FIG. 5 is a partial side view of spectacles according to a second embodiment of the invention;

FIG. 6a is a transverse cross-sectional view of the arm of the spectacles illustrated in FIG. 5 along axis CC;

FIGS. 6b and 6c are longitudinal cross-sectional views of the arm of the spectacles illustrated in FIG. 5, along with horizontal (XY) and vertical (XZ) cutting planes, respectively;

FIG. 7 is a partial side view of spectacles according to a third embodiment of the invention;

FIG. 8 is a transverse cross-sectional view of an arm of spectacles according to a fourth embodiment of the invention;

FIG. 9 is a transverse cross-sectional view of an arm of spectacles according to a fifth embodiment of the invention;

FIG. 10 is a transverse cross-sectional view of an arm of spectacles according to a sixth embodiment of the invention;

FIG. 11a is a perspective view of an arm of spectacles according to a seventh embodiment of the invention;

FIGS. 11b and 11c are transverse cross-sectional views of the spectacle arm illustrated in FIG. 11a, along axes DD and EE, respectively, illustrating the assembly of the decorative sleeve around two distinct portions of the arm frame;

FIG. 12 is a transverse cross-sectional view of a spectacle arm according to an eighth embodiment of the invention.

### DETAILED DESCRIPTION

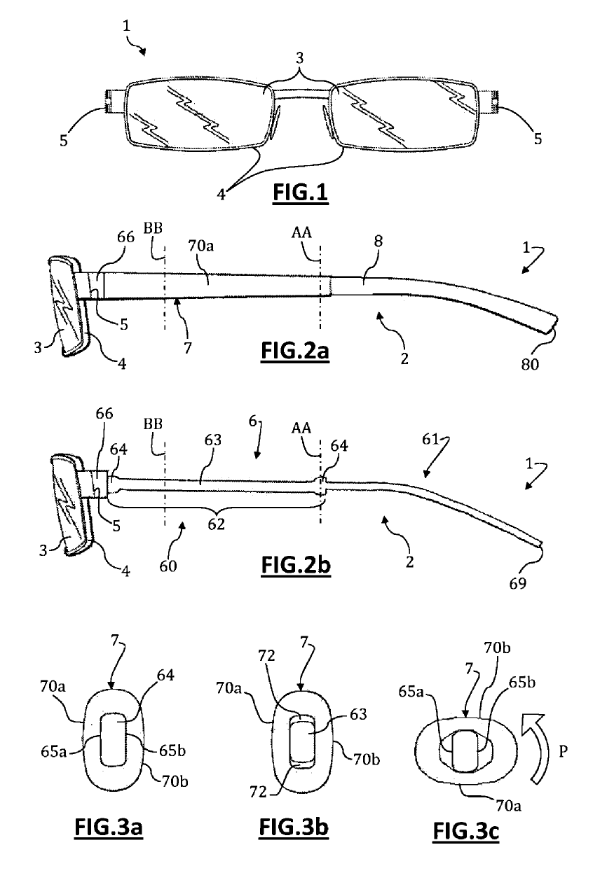

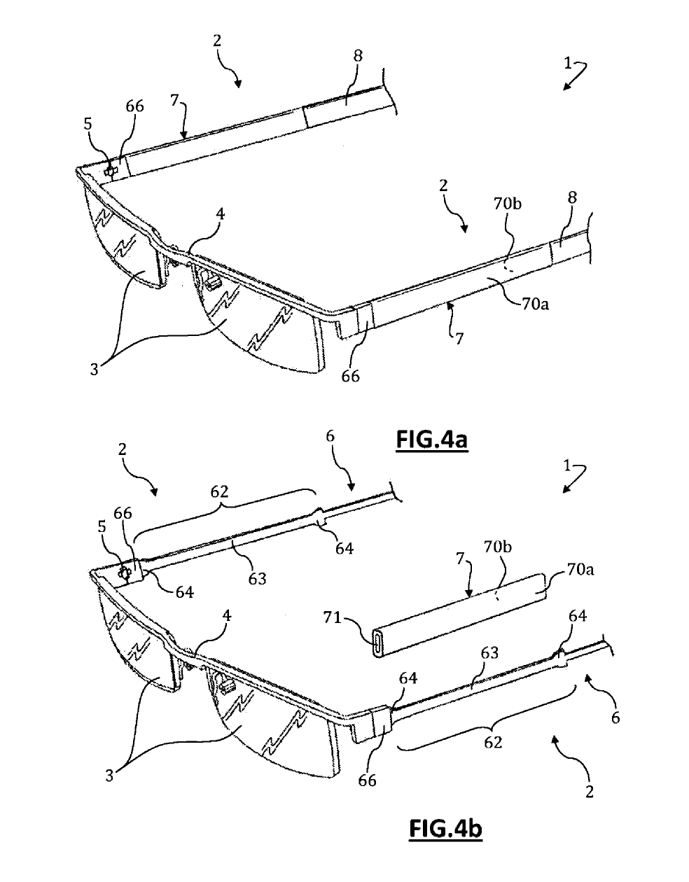

The spectacles 1 and the spectacle arms 2 according to the invention are described in reference to FIGS. 1 to 7, in which the same references are used to illustrate identical or similar parts.

The spectacles 1 comprise:

a face 3, provided with optical and/or solar lenses, said face being supported or not by a spectacle frame 4; and

two spectacle arms 2 according to the invention, called right and left side arms, respectively, connected to the face 3 or to the spectacle frame 4 via a pin and an associated hinge 5.

Each spectacle arm 2 comprises:

a rigid frame 6, in particular made from steel, a composite material, or rigid plastic, which is essentially made up of two parts, i.e. a substantially straight front part 60 connected to the face 3 or to the frame of the spectacles 4, and a curved back the part 61 intended to fit behind the ear and possibly to bear on the ear; and

at least one decorative sleeve 7 at least partially made from an elastically deformable material, provided with two decorative surfaces 70a, 70b and grippingly mounted around the frame 6, said sleeve 7 being designed to rotate around the frame 6 by elastic deformation so as to expose one or the other of the decorative surfaces 70a, 70b.

Exposing one or the other of the decorative surfaces 70a, 70b refers to positioning, on the outside of the spectacle arms 2, opposite the wearer of the spectacles, one or the other of the decorative surfaces 70a, 70b so as to make it visible to surrounding people.

Decorative surface refers to a surface provided with a declaration. Such a decoration may assume the form of a selected color and/or selected patterns. Such patterns can be made in the form of raised and/or hollow and/or colored patterns and/or materials.

The or each sleeve 7, in particular made using an injection molding technique of an elastomer material such as rubber, assumes the form of a tubular piece, elastically deformable, having an internal housing 71 over the entire length of the sleeve 7 and in which the frame 6 passes.

To obtain a sleeve 7 having two decorative surfaces 70a, 70b with different decorations, it is possible to consider making it using a multi-material injection molding technique, in other words through the successive injection of given decorative materials. It is also possible to consider, as a supplement or replacement for the multi-material injection technique, applying a layer of paint or varnish on the sleeve after molding.

The description below relates to a first embodiment of the spectacles 1 and arms 2, done in reference to FIGS. 1 to 4.

The sleeve 7 is mounted around a segment 62 of the frame 6, said segment 62 having a central portion 63 and two end portions 64 and defining two opposite support surfaces, front 65a (on the side opposite the spectacles wearer) and rear 65b (on the side of the spectacles wearer), respectively.

This segment 62 is situated in the front part 60 of the frame 6. The central portion 63 has a constant section and oblong shape. Each end portion 64 has widened section relative to the central portions 63 and also has an oblong shape, i.e. the end portions 64 are wider than the central portion 63.

The internal housing 70 of the sleeve 7 has a substantially constant section, with an oblong shape, so as to at least partially hug the segment 62 of the frame 6 over the entire length of the segment 62.

As visible in FIG. 3a, the sleeve 7 is mounted substantially without play around the two end portions 64 of the segment 62 so as to make it possible to align said sleeve 7 with elements adjacent to the sleeve 7, positioned on either side of the segment 62, such as for example it tip 8 mounted around the rear part 61 of the frame 6 and the front edge 66 of the frame 6 on which the hinge 5 is partially fixed. To that end, each end portion 64 has a shape substantially complementary and dimensions substantially identical to those of the internal housing 71 so as to hug the inside of the sleeve 7 as closely as possible.

As visible in FIG. 3b, the sleeve 7 is mounted with play around the central portion 63 of the segment 62 so as to facilitate the elastic deformation of the sleeve 7 when the latter rotates around said segment 62 by a half-revolution, as illustrated in FIG. 3c. To that end, the central portion 63 has smaller dimensions than those of the internal housing 71 so that plays 72 (visible in FIG. 3b) are provided between the central portion 63 and the sleeve 7; such plays 72 subsequently make it possible to decrease the force necessary to rotate the sleeve 7 around the frame 6, the pivoting of the sleeve 7 being illustrated by arrow P in FIG. 3c.

In the case of FIGS. 3a and 3b, the decorative surface 70a is exposed while being positioned on the same side as the front support surface 65a of the segment 62, while the decorative surface 70b is not exposed while being positioned on the same side as the rear support surface 65b of the segment 62. The pivoting P over a half-revolution, i.e. 180°, thus makes it possible to expose the decorative surface 70b while bringing it to the same side as the front support surface 65a of the segment 62, while the decorative surface 70a is concealed by being brought to the same side as the rear support surface 65b of the segment 62.

The tip 8 can also constitute a decorative sleeve of the same type as the sleeve 7 described above, while being mounted around the rear part 61 of the frame 6. This tip 8 is thus made from an elastically deformable material and differs from the sleeve 7 described above in that one of its ends 80 is plugged to be able to cover the rear end 69 (or free end opposite the face 3) of the frame 6.

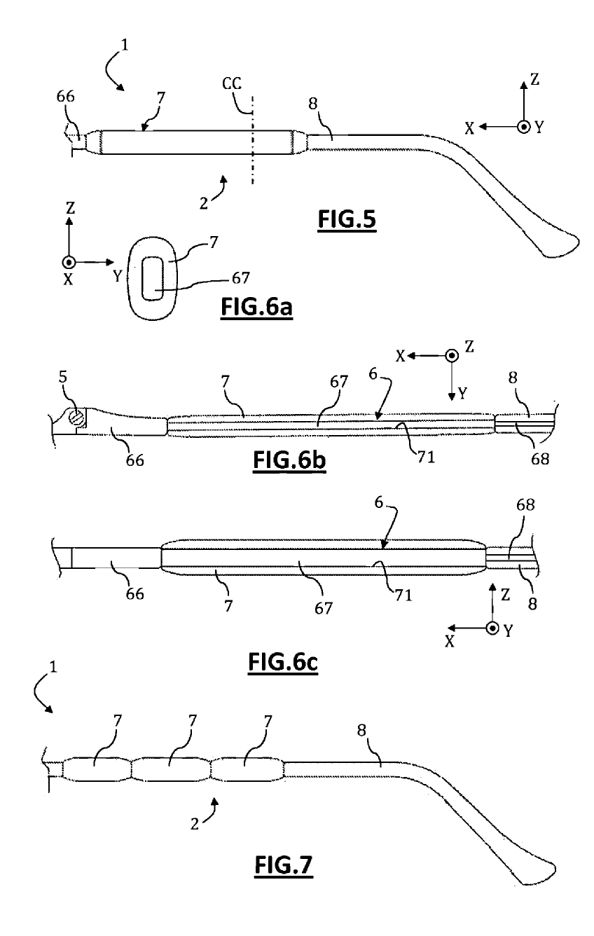

The description below relates to a second embodiment of the spectacles 1 and arms 2, done in reference to FIGS. 5 to 6.

The sleeve 7 is mounted around a central segment 67 of the frame 6. The central segment 67 is situated in the front part 60 of the frame 6, and has a constant section and oblong shape over its entire length. In that case, the central portion and the end portions of said central segment 67 are identical in terms of shape and dimensions, compared to the segment 62 described above for the first embodiment.

The central segment 67 is framed by a rear segment 68 of the frame 6, around which the tip 8 is mounted, and the front edge 66 of the frame 6 on which the hinge 5 is partially fixed, where said front edge 66 has a dimension larger than that of the central segment 67.

The internal housing 71 of the sleeve 7 has a substantially constant section and oblong shape.

As visible in FIGS. 6a to 6c, the sleeve 7 is mounted substantially without play around the central segment 67, in other words the sleeve 7 completely hugs the central segment 67 of the frame 6, over the entire length thereof. To that end, the central segment 67 has a substantially complementary shape and dimensions substantially identical to those of the internal housing 71 so as to hug the inside of the sleeve 7 as closely as possible.

In this way, the sleeve 7 is pinched between the front edge 66 and the tip 8, while abutting against the front edge 66 and the tip 8.

The description below relates to a third embodiment of the spectacles 1 and arms 2, done in reference to FIGS. 7.

The spectacles 1 have several sleeves 7 mounted around the frame 6. In the case at hand, these sleeves 7 are successively mounted one behind the other along the frame 6. It is of course possible to consider providing intermediate pieces mounted around the frame 6 and inserted between the sleeves 7 and/or to provide intermediate segments of the frame 6 between the sleeves 7.

The description below relates to fourth, fifth, sixth and seventh embodiments of the spectacles 1 and arms 2, done in reference to FIGS. 8 to 11, respectively.

In these embodiments, the sleeve 7 comprises at least one first part 72, 74, 76 completely made from an elastically deformable material, and at least one rigid second part 73, 75, 77 secured to the first part 72, 74, 76 and defining at least one decorative surface 70c, 70d.

In the fourth embodiment illustrated in FIG. 8, the first part 72 is made in the form of a ring of elastically deformable material that is mounted around the frame 6, and the second part 73 is made in the form of a rigid ring or crown fixed on the perimeter of the first part 72 and which completely surrounds said first part 72. In this way, the first part 72 forms a sort of core of elastically deformable material able to deform enough to allow the sleeve 7 to rotate around the frame 6.

In the fifth embodiment illustrated in FIG. 9, the first part 72 is also made in the form of a ring of elastically deformable material that is mounted around the frame 6, and the second part 73 is made in the form of a rigid plate fixed on the perimeter of the first part 72 and which surrounds one side of said first part 72.

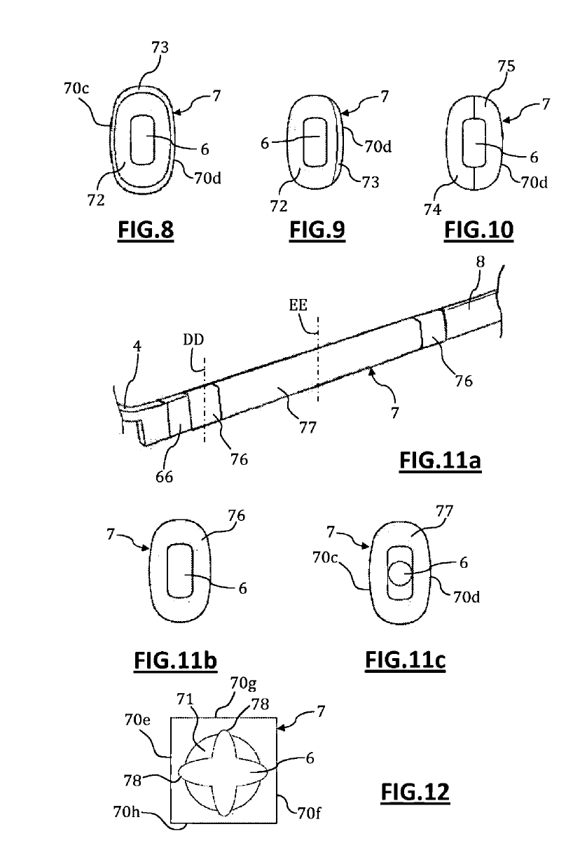

In the sixth embodiment illustrated in FIG. 10, the first part 74 and the second part 75 each form a half-ring made from an elastically deformable material and a rigid material, respectively, said first and second parts being attached to one another to form the sleeve together, where the first part 74 is capable of deforming enough to allow the sleeve 7 to rotate completely around the frame 6.

In the seventh embodiment illustrated in FIGS. 11a to 11c, the sleeve 7 comprises two first parts 76 made in the form of rings of elastically deformable material and a second part 77 made in the form of a ring of rigid material. The first parts 76 are fixed on the end of the second part 77 so as to frame said second part 77, which thus forms the central part of the sleeve 7. As visible in FIG. 11b, the first parts 76 are mounted around respective non-cylindrical segments of the frame 6 so as to allow the sleeve 7 to be immobilized around the frame 6. As visible in FIG. 11c, the second rigid part 77 is mounted around the frame 6 so as to be able to rotate around the frame 6 when the sleeve 7 is rotated.

Of course, the embodiment described above is in no way limiting, and other details and improvements may be made to the arms according to the invention, without going beyond the scope of the invention, where other sleeve shapes and/or arms shapes can be produced.

For example, the frame segment around which the sleeve is mounted may have a triangular section, and the sleeve may have three decorative surfaces, so that it is possible to expose one of the three decorative surfaces by pivoting by more or less 120°.

In another example corresponding to the eighth embodiment illustrated in FIG. 12, the segment of the frame 6 around which the sleeve 7 is mounted has a transverse section in the shape of a star or cross with four branches with rounded edges, and the sleeve 7 has a square outer section defining four decorative surfaces 70e, 70f, 70g, 70h, so that it is possible to expose one of the four decorative surfaces by pivoting by more or less 90° or 180°. The sleeve 7 has a quasi-cylindrical internal housing 71 with spaces 78, made in the form of longitudinal slots formed in the frame 6. These spaces 78 perform a centering and immobilization function of the sleeve 7 in the four decorative positions of the sleeve 7.

1. An arm for spectacles, comprising:
a frame, characterized in that it comprises at least one and
at least one decorative sleeve at least partially made of an elastically deformable material, provided with at least one decorative surface and mounted around the frame,
wherein the sleeve is designed to turn and/or twist around the frame by means of elastic deformation in order to modify an appearance of said arm.

2. The arm according to claim 1, wherein the sleeve is provided with at least two decorative surfaces, said sleeve being designed to turn and/or twist around the frame by elastic deformation so as to expose one and/or the other of the decorative surfaces.

3. The arm according to claim 1, comprising several sleeves mounted around the frame of the arm.

4. The arm according to claim 1, wherein the sleeve at least partially fits a rear curved portion of the frame intended to fit behind an ear.

5. The arm according to claim 4, wherein the sleeve has a plugged end in order to cover a free end of the frame, such that said sleeve forms a tip mounted around a rear portion of the frame.

6. The arm according to claim 1, wherein the sleeve at least partially fits a substantially straight front portion of the frame intended to be connected to a face of the spectacles.

7. The arm according to claim 1, wherein the sleeve is mounted around a segment of the frame of the arm, said segment having a central portion and two end portions, and wherein the sleeve is mounted without play around at least one of the portions of said segment so as to make it possible to immobilize the sleeve in position around said segment.

8. The arm according to claim 7, wherein the sleeve is mounted around the segment of the frame of the arm, said segment having a central portion and two end portions, and wherein the sleeve is mounted with play around at least one of the portions of said segment so as to facilitate the elastic deformation of sleeve when said sleeve rotates around said segment.

9. The arm according to claims 7, wherein the sleeve is either mounted with play around the central portion of the segment and without play around at least one of the end portions of the segment, or mounted without play around the central portion of the segment and without play around at least one of the end portions of the segment.

10. The arm according to claim 9, wherein the sleeve has an internal housing with a substantially constant section, and wherein at least one of the end portions, or the central portion, respectively, of the segment has a widened transverse section relative to said central portion, or respectively at least one of the end portions of the segment has a shape substantially complementary to that of the internal housing.

11. The arm according to claim 9, wherein the segment has a substantially constant section and the sleeve has an internal housing provided with a central portion and two end portions, and wherein at least one of the end portions, or the central portion, respectively, of the housing has a reduced transverse section relative to the central portion, or at least one of the end portions, respectively, of the housing and a shape substantially complementary to that of the segment.

12. The arm according to claim 1, wherein the sleeve is mounted around a segment of the frame with a non-circular transverse section so as to ensure rotational indexing of the sleeve around the frame.

13. The arm according to claim 1, wherein the sleeve is mounted around a segment of the frame with a circular transverse section, and wherein the adhesion between the sleeve and the segment is sufficient to keep the sleeve in a twisted position around said segment.

14. The arm according to claim 1, wherein the sleeve is made by molding at least one elastically deformable material.

15. The arm according to claim 1, wherein the sleeve is made completely from an elastically deformable material.

16. The arm according to claim 1, wherein the sleeve comprises at least one first part completely made from an elastically deformable material, and at least one second rigid part secured to the first part and defining at least one decorative surface.

17. The arm according to claim 16, wherein the first part is made in the form of a ring of elastically deformable material, and the second part comprises a rigid wall fixed on the perimeter of the first part and which at least partially surrounds said first part.

18. The arm according to claim 16, wherein the first part and the second part each form and a half-ring respectively made from an elastically deformable material and a rigid material, said first and second parts being joined to one another to form the sleeve together.

19. The arm according to claim 16, wherein the sleeve comprises at least two first parts made in a form of rings of an elastically deformable material and at least one second part made in a form of a ring rigid material, said first parts being fixed on the end of the second part so as to frame said second part and make it possible to immobilize the sleeve around the frame.

20. A pair of spectacles comprising at least one arm according to claim 1.
